(19) United States
(12) Patent Application Publication
(10) Pub. No.: US 2025/0018669 A1
(43) Pub. Date: Jan. 16, 2025

(54) REPARATION METHOD OF EYE-TRACKING GLASSES

(71) Applicants: Asphetek Solution (Chengdu) Ltd., Sichuan (CN); Asphetek Solution Inc., Hsinchu (CN); ADVANCED OPTOELECTRONIC TECHNOLOGY, INC., Hsinchu Hsien 303 (TW)

(72) Inventors: YING-HUNG TSAI, Hsinchu (TW); CHUNG-WU LIU, Hsinchu (TW); I-MING CHENG, Hsinchu Hsien (TW); YI-HUAN CHOU, Hsinchu Hsien (TW)

(21) Appl. No.: 18/240,156

(22) Filed: Aug. 30, 2023

(30) Foreign Application Priority Data
Jul. 13, 2023 (CN) 202310861534.2

(51) Int. Cl. B29D 11/00; B29C 45/14; B29C 45/26; G02C 11/00

(52) U.S. Cl. CPC B29D 11/0073; B29C 45/14065; B29C 45/26; B29D 11/0074; B29D 11/00951; G02C 11/10; B29K 2105/0097; B29K 2679/08; B29K 2909/08; B29K 2995/0031; B29L 2011/0016

(57) ABSTRACT

A method for preparing eye-tracking glasses, comprising the following steps: providing a substrate assembly, the substrate assembly comprising a functional film, the functional film being arranged on a surface of the substrate assembly, and electronic components being arranged on the surface of the functional film. Pressing an injection mold against the substrate assembly to form an injection cavity, and making the surface of the functional film with the electronic components face an interior of the injection cavity. Injecting and molding an optical adhesive in the injection cavity to form a lens, with the electronic components embedded in the lens. Demolding the injection mold from the lens, separating the functional film from the substrate assembly to obtain the eye-tracking glasses.

### FIELD

The subject matter relates to the technical field of headsets, and in particular, to a preparation method of eye-tracking glasses.

### BACKGROUND

Eye-tracking technology is a technology that uses mechanical, electronic, optical and other detection methods to obtain a user's current “gaze direction”. With the rapid development of computer vision, artificial intelligence technology and digital technology, eye-tracking technology has become a hot research field and has been widely used in the field of human-computer interaction. For example, it can be applied to virtual reality, augmented reality, vehicle assisted driving, user experience, cognitive impairment diagnosis and other fields. When eye-tracking technology is implemented in headsets such as virtual reality devices and augmented reality devices, it is often necessary to set up light sources and cameras in headsets. In order to ensure the user experience and avoid obstructing the user's line of sight, the light source needs to be set in a suitable position.

Usually, eye-tracking technology can generally be divided into categories such as pupil corneal reflection, retinal imaging, calculation of visual center based on eye modeling, retinal reflection intensity, and corneal reflection intensity. Among the aforementioned eye-tracking technology classifications, the first method, pupil corneal reflection, the second method, retinal imaging, and the third method, calculation of visual center based on eye modeling, all require the use of a camera. The first two methods, pupil corneal reflection and retinal imaging, process and extract feature points from the eye image using a computer to obtain the visual center of the eye. The third method, calculation of visual center based on eye modeling, requires reconstructing the eye into a three-dimensional model using a camera (infrared or depth camera), and then calculating the visual center. The fourth method, retinal reflection intensity, and the fifth method, corneal reflection intensity, only require one or a few photosensitive sensor components to capture the intensity of the reflected light from the eye to obtain the visual center of the eye. The reflected light may come from the center of the cornea or the retina. Clearly, utilizing photosensitive sensors to achieve eye-tracking has certain advantages.

However, in the existing technology, the process of setting photosensitive sensors on the lens mainly involves encapsulating the photosensitive sensors on a substrate first. After encapsulation is completed, a solid-state optical adhesive is applied to adhere the photosensitive sensors to the surface of the lens. However, this method involves multiple coating, drying, shaping, and other processes, which are time-consuming and difficult to control the uniformity of each layer, resulting in unstable yield of the final product. How to produce eyeglasses with photosensitive sensors that can realize eye-tracking technology through a stable and efficient process is a consideration for those skilled in the art.

### BRIEF DESCRIPTION OF THE DRAWINGS

FIG. 1 is a schematic view of the process of preparation method of eye-tracking glasses.

FIG. 2 is a schematic view of a partial process structure of the preparation method of eye-tracking glasses.

FIG. 3 is a schematic view of a partial process structure of the preparation method of eye-tracking glasses.

FIG. 4 is a schematic view of a partial process structure of the preparation method of eye-tracking glasses.

FIG. 5 is a schematic view of a partial process structure of the preparation method of eye-tracking glasses.

FIG. 6 is a schematic view of a partial process structure of the preparation method of eye-tracking glasses.

FIG. 7 is a schematic view of a partial process structure of the preparation method of eye-tracking glasses.

FIG. 8 is a schematic view of a partial process structure of the preparation method of eye-tracking glasses.

### DETAILED DESCRIPTION

The following descriptions refer to the attached drawings for a more comprehensive description of this application. Sample embodiments of this application are shown in the attached drawings. However, this application can be implemented in many different forms and should not be construed as limited to exemplary embodiments set forth herein. These exemplary embodiments are provided to make this application thorough and complete, and to adequately communicate the scope of this application to those skilled in the field. Similar view labels represent the same or similar components.

The terms used herein are intended only to describe the purpose of particular exemplary embodiments and are not intended to limit this application. As used herein, the singular forms “one” and “the” are intended to include the plural as well, unless the context otherwise clearly indicates it. In addition, when used herein, the words “include” and/or “have”, integers, steps, operations and/or components, do not exclude additional or pluralities of features, regions, integers, steps, operations, components, and/or groups thereof.

Unless otherwise defined, all terms used herein (including technical and scientific terms) have the same meaning as would normally be understood by ordinary technicians in the field of this application. In addition, unless expressly defined in the context, terms such as those defined in a general dictionary shall be construed to have meanings consistent with those in the relevant technology and in the content of this application, and shall not be construed to have idealistic or overly formal meanings.

Examples of embodiments are described below in combination with the attached drawings. It should be noted that the components depicted in the attached drawings may be shown not to scale; the same or similar components will be assigned the same or similar drawing mark representation or similar technical terms.

Usually, eye-tracking technology can generally be divided into methods such as pupil corneal reflection, retinal imaging, calculation of visual center based on eye modeling, retinal reflection intensity, and corneal reflection intensity. Among the aforementioned eye-tracking technology classifications, the first method, pupil corneal reflection, the second method, retinal imaging, and the third method, calculation of visual center based on eye modeling, all require the use of a camera. The first two methods, pupil corneal reflection and retinal imaging, process and extract feature points from the eye image using a computer to obtain the visual center of the eye. The third method, calculation of visual center based on eye modeling, requires reconstructing the eye into a three-dimensional model using a camera (infrared or depth camera), and then calculating the visual center. The fourth method, retinal reflection intensity, and the fifth method, corneal reflection intensity, only require one or a few photosensitive sensor components to capture the intensity of the reflected light from the eye to obtain the visual center of the eye. The reflected light may come from the center of the cornea or the retina.

Clearly, utilizing photosensitive sensors to achieve eye-tracking has certain advantages. However, the process of setting photosensitive sensors on the lens mainly involves encapsulating the photosensitive sensors on a substrate first. After encapsulation is completed, a solid-state optical adhesive is applied to adhere the photosensitive sensors to the surface of the lens. However, this method involves multiple coating, drying, shaping, and other processes, which are time-consuming and difficult to control the uniformity of each layer, resulting in unstable yield of the final product.

Correspondingly, the method for preparing eye-tracking glasses comprise the following steps: providing a substrate assembly, the substrate assembly comprising a functional film, the functional film being arranged on a surface of the substrate assembly, and electronic components being arranged on the surface of the functional film. Pressing an injection mold against the substrate assembly to form an injection cavity, and making the surface of the functional film with the electronic components face an interior of the injection cavity. Injecting and molding an optical adhesive in the injection cavity to form a lens, with the electronic components embedded in the lens. Demolding the injection mold from the lens, separating the functional film from the substrate assembly to obtain the eye-tracking glasses.

The preparation method of the eye-tracking glasses described in this application involves pre-setting electronic components for eye-tracking on the surface of the functional film. Subsequently, the injection mold is provided, and the surface of the functional film with the electronic components is oriented towards the interior of the injection cavity. Liquid optical adhesive is injected into the injection cavity and flows to fill various areas inside the injection cavity. During this process, the electronic components on the surface of the functional film are in contact with the optical adhesive, and at least a portion of the electronic components on the surface is encapsulated by the optical adhesive. The optical adhesive then solidifies, embedding the electronic components in the lens, avoiding the problems of uneven adhesive thickness and complex encapsulation processes when directly attaching the electronic components to the surface of the molded lens through an adhesive layer.

The person skilled in the art should understand that “electronic components” refer to the components of electronic devices and small machines and instruments, which are usually composed of several parts and can be commonly used in similar products.

The person skilled in the art should understand that “vertical-cavity surface-emitting laser” refers to a class of semiconductors that emit laser light vertically from the top surface. It is commonly known as VCSEL.

The person skilled in the art should understand that “infrared emitting diode” refers to a diode that emits infrared light, also known as an IR LED.

The person skilled in the art should understand that “polyimide” refers to a type of polymer that contains imide rings (—CO—NR—CO—) on the main chain. It has good optical properties and is commonly known as PI.

The person skilled in the art should understand that “optical adhesive” refers to a material with good transparency, such as OCA (Optically Clear Adhesive) or OCR (Optical Clear Resin). OCR is a liquid form and is also known as liquid optical adhesive or LOCA. After curing, OCR is colorless and transparent, with a transmittance of over 98%, and it has characteristics such as low curing shrinkage and resistance to yellowing.

The following is a detailed description of the specific implementation of this application, referring to the attached drawings.

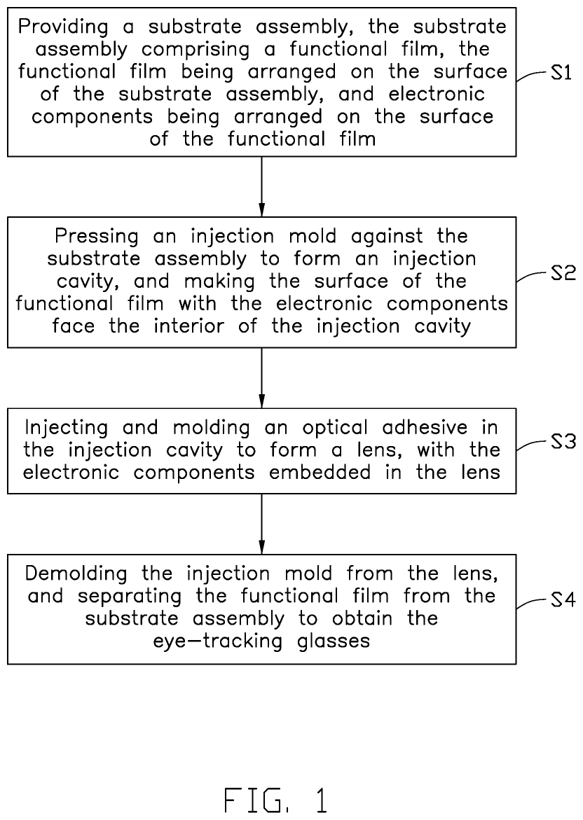

As shown in FIG. 1, the present application provides a method for preparing eye-tracking glasses 10, comprising the following steps:

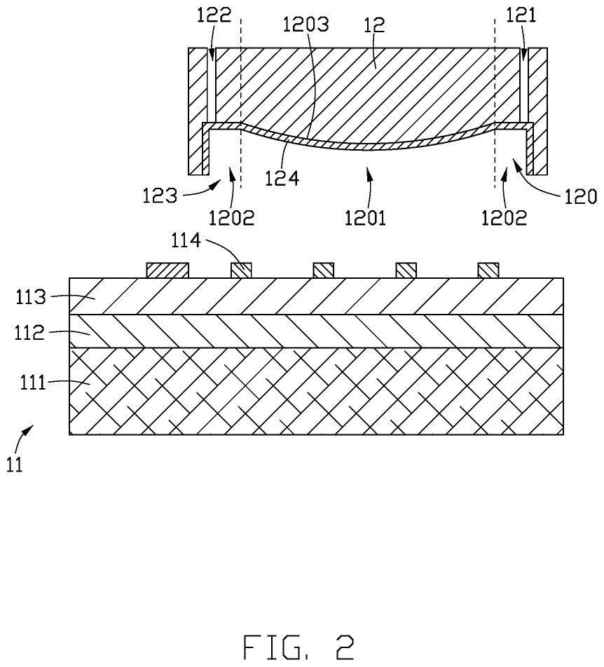

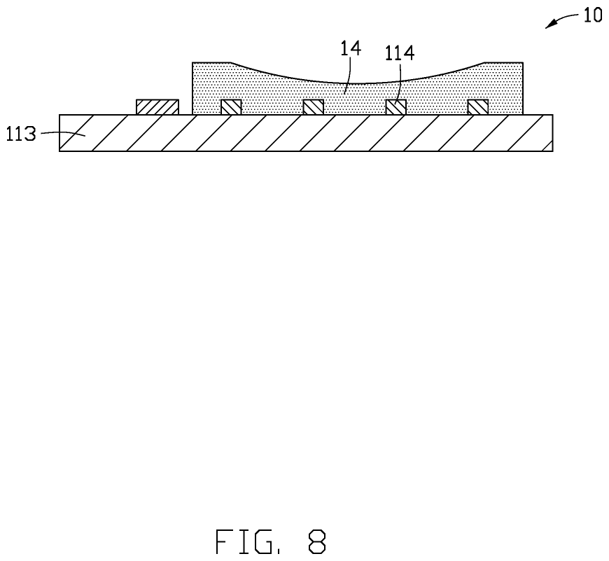

Step S1: Referring to FIGS. 2 and 8, provide a substrate assembly 11, with a functional film 113 set on the surface of the substrate assembly 11. The surface of the functional film 113 is equipped with electronic components 114.

In this embodiment, by arranging the electronic components 114 on the surface of the functional film 113, the pre-determined positions of the electronic components 114 are achieved. The functional film 113 can serve as a carrier for the electronic components 114. Fixing multiple electronic components 114 on the surface of the functional film 113 in order to determine the mutual positional relationship between multiple electronic components 114. The wiring (not shown) for connecting the electronic components 114 to each other or to external circuits (such as flexible circuits) can also be set on the surface of the functional film 113, which is carried by the functional film 113 in advance.

In one embodiment, the substrate assembly 11 further includes a support plate 111 and a matching film 112. The matching film 112 is set on the surface of the support plate 111. The functional film 113 is set on the surface of the matching film 112, away from the support plate 111. The functional film 113 can be in separate contact with the matching film 112. The electronic components 114 are located on the side of the functional film 113 away from the matching film 112. The material of the functional film 113 includes polyimide.

The functional film 113 will be attached to the surface of the lens 14 of the glasses after subsequent processing. The functional film 113 should be made of a material with good optical effects (such as polyimide, PI). Similarly, in order to minimize the impact of the functional film 113 on the optical performance of the lens 14, the functional film 113 is preferably a thinner film. However, thinner film materials may have poor self-supporting performance, making it difficult to process or negatively affecting the overall processing efficiency. Therefore, a hard support plate 111 is introduced, which can be made of glass. The functional film 113 is carried by the hard support plate 111, facilitating subsequent processing and the arrangement of electronic components 114. Considering the possible issues with adhesion between the glass support plate 111 and the polyimide functional film 113, such as the occurrence of wrinkles on the surface of the support plate 111 due to temperature changes, the matching film 112 is further introduced between the support plate 111 and the functional film 113. This allows the functional film 113 to be better attached to the surface of the support plate 111 without deformation. At the same time, the material of the matching film 112 mainly considers the adhesion effect between the support plate 111 and the functional film 113. The optical performance of the matching film 112 may not meet the requirements of the lens 14, so it is necessary to set the matching film 112 to be in separate contact with the functional film 113. This allows the matching film 112 to be detached from the functional film 113, as well as facilitating the separation of the functional film 113 from the support plate 111.

In one embodiment, the electronic components 114 include at least one of a vertical cavity surface emitting laser and an infrared light-emitting diode.

The vertical cavity surface emitting laser and the infrared light-emitting diode can be applied to the eye-tracking glasses 10. The vertical cavity surface emitting laser and the infrared light-emitting diode can be set in the peripheral area of the eye-tracking glasses 10. The respective wirings which connect to the vertical cavity surface emitting laser and the infrared light-emitting diode can be led out to the edge of the eye-tracking glasses 10, enabling tracking of the wearer's eye movement.

In one embodiment, the electronic components 114 further include a component with signal relay function connected to the vertical cavity surface emitting laser and the infrared light-emitting diode. This component with signal relay function is not located in the injection cavity 120 and is positioned on the outer side of the lens 14 to enable electrical connection between the lens 14 and external circuits.

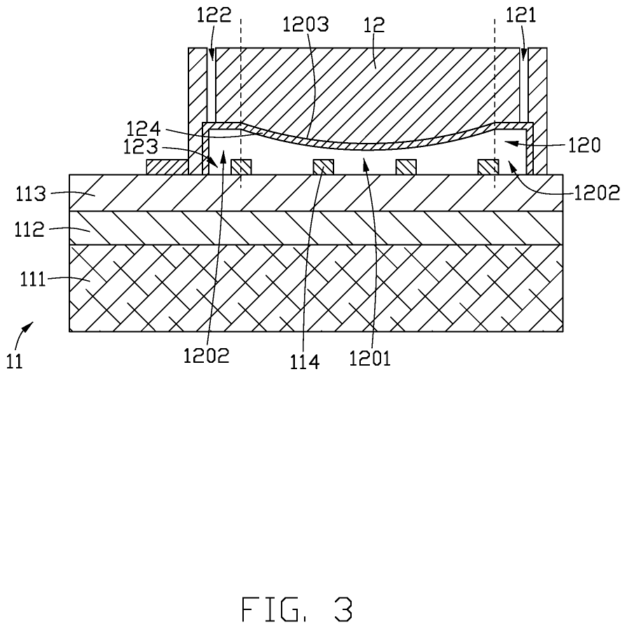

Step S2: Referring to FIGS. 3 and 8, provide an injection mold 12, which is coupled with the substrate assembly 11 to form an injection cavity 120, with the surface of the functional film 113 holding the electronic components 114 facing the inside of the injection cavity 120.

In one embodiment, the injection mold 12 is constructed to form a concave shape to create the injection cavity 120. The injection mold 12 has an opening 123, which can be covered by the functional film 113 when the injection mold 12 is coupled with the substrate assembly 11 or exposed when the injection cavity 120 is open.

The injection cavity 120 is used for injection molding the lens body of eye-tracking glasses 10. The eye-tracking glasses 10 should have basic optical characteristics of glasses. The eye-tracking glasses 10 can be designed as a concave lens shape to meet the basic optical characteristics of glasses, with one side of the concave lens being relatively flat and the other side having uneven thickness distribution. In order to reduce the difficulty of the manufacturing process, in this embodiment, the substrate assembly 11 is set to a relatively flat state and is matched with the opening 123 of the injection mold 12. The injection mold 12 is constructed as an inwardly concave shape to adjust the thickness of each part of the concave lens and thus achieve the casting of the eye-tracking glasses 10.

In one embodiment, the injection mold 12 is also provided with an injection through-hole 121 and a vacuum suction through-hole 122. The injection through-hole 121 and the vacuum suction through-hole 122 are respectively connected to the injection cavity 120. The injection through-hole 121 and the vacuum suction through-hole 122 are located on the side opposite to the opening 123 of the injection cavity 120.

The injection through-hole 121 can be used to inject liquid optical adhesive into the injection cavity 120, and the vacuum suction through-hole 122 can be used to help reduce the vacuum degree inside the injection cavity 120, ensuring a smooth injection process.

In one embodiment, the injection cavity 120 is constructed with a thinner middle area 1201 and a thicker outer area 1202 to form the concave lens-shaped lens 14. The injection through-hole 121 and the vacuum suction through-hole 122 correspond to the outer area 1202 of the injection cavity 120, and the injection through-hole 121 and the vacuum suction through-hole 122 are spaced on both sides of the middle area 1201 of the injection cavity 120.

The injection through-hole 121 and the vacuum suction through-hole 122 can correspond to the two thickest areas of the outer area 1202, allowing the liquid optical adhesive 15 to have good filling in the injection cavity 120 and ensuring a higher production yield of the formed eye-tracking glasses 10.

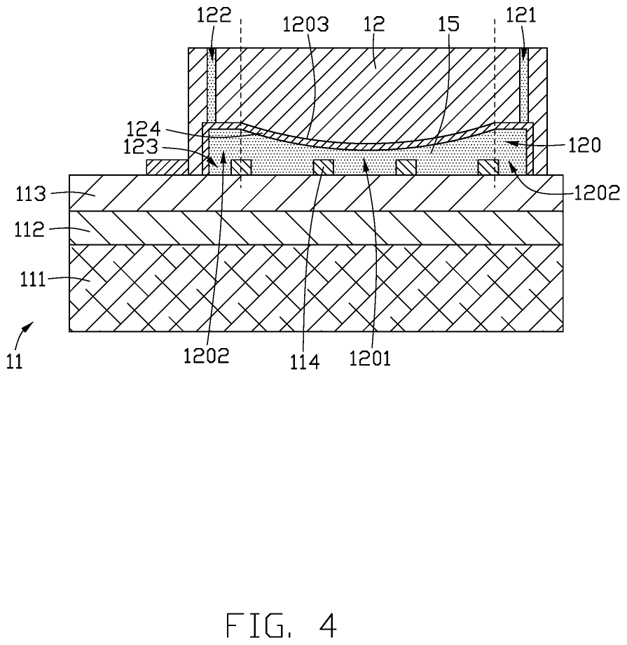

Step S3: Referring to FIGS. 4 and 8, inject the optical adhesive 15 into the injection cavity and mold the lens 14, with electronic components 114 embedded in the lens 14.

Understandably, after the liquid optical adhesive 15 is injected into the injection cavity 120, it gradually fills the various regions of the injection cavity 120 before solidification. During this process, the exposed surface of the electronic components 114 will be covered by the liquid optical adhesive 15. After the liquid optical adhesive 15 solidifies, the electronic components 114 will be embedded and mounted on the lens 14.

Though the injection molding method to obtain the lens 14, which allows the production and connection of the lens 14 and electronic components 114 to be completed in one step, improving efficiency and reducing manufacturing time compared to existing techniques.

In one embodiment, the optical adhesive 15 includes optical glue or optical clear resin.

Understandably, the optical adhesive 15 can be OCA (Optically Clear Adhesive) or OCR (Optical Clear Resin), with OCR being preferred.

In one embodiment, the refractive index of the optical adhesive 15 is greater than or equal to 1.

In one embodiment, the refractive index of the optical adhesive 15 ranges from 1.48 to 1.53.

Understandably, controlling the refractive index of the optical adhesive 15 to be greater than or equal to 1, preferably ranging from 1.48 to 1.53, ensures that the eye-tracking glasses 10 have good overall optical performance.

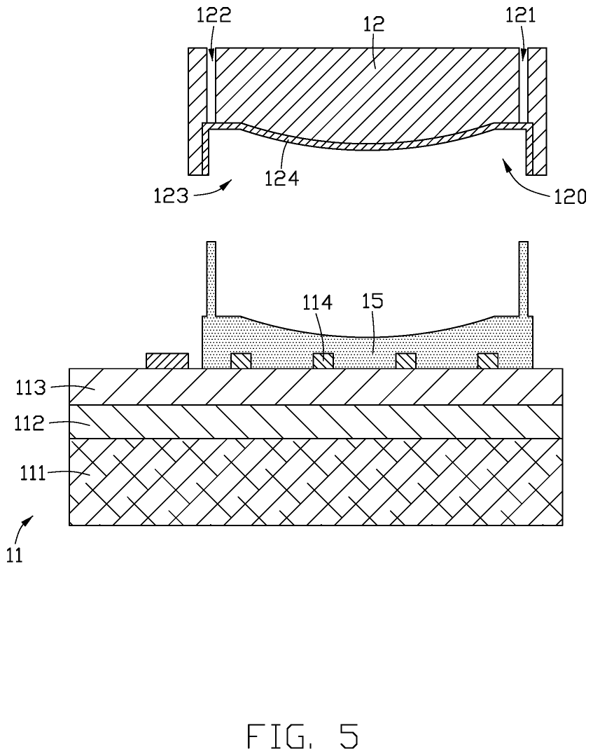

Step S4: Referring to FIGS. 5 to 8, the injection mold 12 and lens 14 are demolded, and the functional film 113 is separated from the substrate assembly 11 to obtain eye-tracking glasses 10.

In one embodiment, to facilitate the demolding of the lens 14 from the injection mold 12, a release film 124 connected to the inner surface 1203 of the corresponding injection cavity 120 of the injection mold 12 can be set. In other embodiments, the materials of the injection mold 12 and optical adhesive 15 can be adjusted to facilitate the removal of the optical adhesive 15 from the injection mold 12.

In one embodiment, after the injection mold 12 and lens 14 are demolded, the lens 14 is shaped and polished, and the functional film 113 is shaped and undergoes electrical connection processing after being separated from the substrate assembly 11.

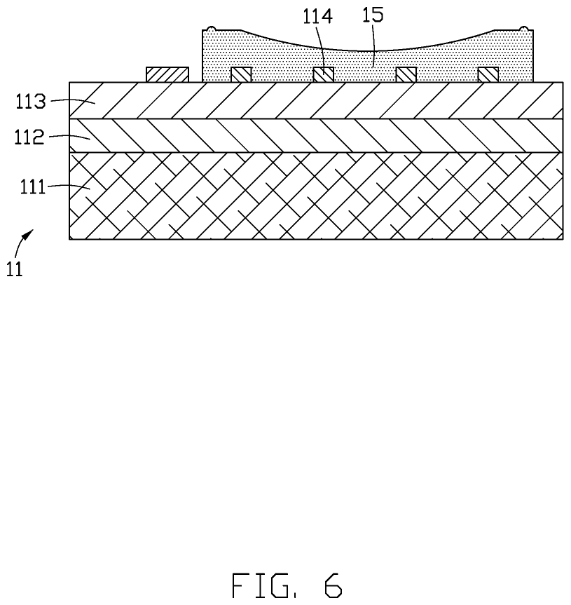

Referring further to FIGS. 5 and 6, after the injection mold 12 and lens 14 are demolded, there will be excess material on the surface of the lens 14, such as excess molding material corresponding to the injection through-hole 121 and vacuum extraction through-hole 122, or other burrs. Laser or other means are required to remove the excess material from the lens 14 to ensure the optical structure of the lens 14 is not damaged.

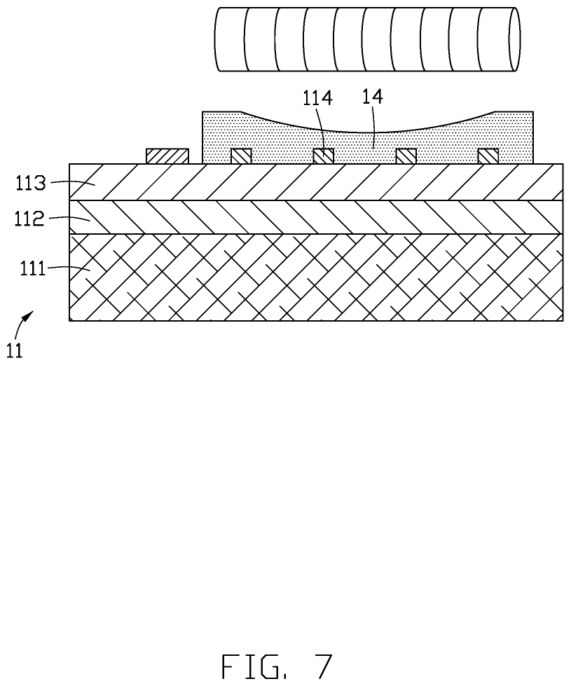

Furthermore, as shown in FIGS. 7 and 8, after removing the excess material from the lens 14, the lens 14 surface can be polished to achieve a higher flatness, resulting in eye-tracking glasses 10.

The proportions of the eye-tracking glasses 10 shown in FIG. 8, including the lens 14 and functional film 113, are for illustrative purposes only to understand the structural relationship between the lens 14 and functional film 113, and do not represent the actual dimensions and proportions of the product. In practical applications, the size of the lens 14 corresponds to the common thickness of the actual product, and the thickness of the functional film 113 should be much smaller than the thickness of the lens 14. The functional film 113 should cover the main surface of the lens 14 or further encapsulate the edge of the lens 14. Any part of the functional film 113 that exceeds the edge of the lens 14 can be removed by cutting in the preceding steps.

The preparation method of the eye-tracking glasses 10 described in this application involves pre-setting electronic components 114 for eye-tracking on the surface of the functional film 113. Subsequently, the injection mold 12 is provided, and the surface of the functional film 113 with the electronic components 114 is oriented towards the interior of the injection cavity 120. Liquid optical adhesive 15 is injected into the injection cavity 120 and flows to fill various areas inside the injection cavity 120. During this process, the electronic components 114 on the surface of the functional film 113 are in contact with the optical adhesive 15, and at least a portion of the electronic components 114 on the surface is encapsulated by the optical adhesive 15. The optical adhesive 15 then solidifies, embedding the electronic components 114 in the lens 14, avoiding the problems of uneven adhesive thickness and complex encapsulation processes when directly attaching the electronic components 114 to the surface of the molded lens 14 through an adhesive layer.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure.

What is claimed is:

1. A preparation method of eye-tracking glasses, comprising:
providing a substrate assembly, the substrate assembly comprising a functional film, the functional film being arranged on a surface of the substrate assembly, and electronic components being arranged on the surface of the functional film;
pressing an injection mold against the substrate assembly to form an injection cavity, and making the surface of the functional film with the electronic components face an interior of the injection cavity;
injecting and molding an optical adhesive in the injection cavity to form a lens, with the electronic components embedded in the lens; and
demolding the injection mold from the lens, and separating the functional film from the substrate assembly to obtain the eye-tracking glasses.

2. The preparation method of eye-tracking glasses of claim 1, wherein the optical adhesive comprises Optically Clear Adhesive or Optical Clear Resin.

3. The preparation method of eye-tracking glasses of claim 1, wherein a refractive index of the optical adhesive is greater than or equal to 1.

4. The preparation method of eye-tracking glasses of claim 1, wherein a refractive index of the optical adhesive ranges from 1.48 to 1.53.

5. The preparation method of eye-tracking glasses of claim 1, wherein the electronic components comprise at least one of a vertical-cavity surface-emitting laser and an infrared light-emitting diode.

6. The preparation method of eye-tracking glasses of claim 1, wherein the substrate assembly further comprises a support plate and a matching film, the matching film is positioned on a surface of the support plate, the functional film is positioned on the surface of the matching film away from the support plate.

7. The preparation method of eye-tracking glasses of claim 6, wherein the functional film is in separable contact with the matching film, and the electronic components are located on a side of the functional film away from the matching film.

8. The preparation method of eye-tracking glasses of claim 1, wherein and material of the functional film comprises polyimide.

9. The preparation method of eye-tracking glasses of claim 1, wherein the injection mold is constructed to be concave inward to form the injection cavity, the injection mold is provided with an opening, the injection cavity is connected to the opening.

10. The preparation method of eye-tracking glasses of claim 9, wherein the injection mold is detachably engaged with the substrate assembly, the opening is covered by the functional film, or the opening is left uncovered to expose the injection cavity.

11. The preparation method of eye-tracking glasses of claim 9, wherein the injection mold further comprises an injection through-hole and a vacuum suction through-hole, the injection through-hole and the vacuum suction through-hole are connected to the injection cavity respectively.

12. The preparation method of eye-tracking glasses of claim 11, wherein the injection through-hole and the vacuum suction through-hole are positioned on a side of the injection cavity opposite to the opening.

13. The preparation method of eye-tracking glasses of claim 11, wherein the injection cavity is constructed with a thinner middle area and a thicker outer area, for forming a concave lens-shaped lens.

14. The preparation method of eye-tracking glasses of claim 13, wherein the injection through-hole and the vacuum suction through-hole are correspondingly arranged in the outer area of the injection cavity, and the injection through-hole and the vacuum suction through-hole are spaced apart on both sides of the middle area of the injection cavity.

15. The preparation method of eye-tracking glasses of claim 1, wherein after demolding the injection mold from the lens, the lens is shaped and polished.

16. The preparation method of eye-tracking glasses of claim 15, wherein after separating the functional film from the substrate assembly, the functional film is shaped and subjected to electrical connection treatment.

17. The preparation method of eye-tracking glasses of claim 1, wherein the injection mold comprises a release film, the release film is connected to an inner surface of a corresponding injection cavity of the injection mold.

18. The preparation method of eye-tracking glasses of claim 1, wherein material of the injection mold and optical adhesive is adjusted to facilitate removal of the optical adhesive from the injection mold.

19. The preparation method of eye-tracking glasses of claim 1, wherein the eye-tracking glasses is designed as a concave lens shape to meet basic optical characteristics of glasses, with one side of the concave lens being relatively flat and another side having uneven thickness distribution.
